(19) United States
(12) Patent Application Publication
(10) Pub. No.: US 2012/0303398 A1
(43) Pub. Date: Nov. 29, 2012

(54) METHOD FOR MANAGEMENT OF POST-SALES SERVICES SUPPLY CHAIN

(75) Inventors: Rahul Singh, Coppell, TX (US); Nitin Ahuja, Grapevine, TX (US)

(73) Assignee: ENTERCOMS, INC., Irving, TX (US)

(21) Appl. No.: 13/482,111

(22) Filed: May 29, 2012

Related U.S. Application Data
(60) Provisional application No. 61/490,137, filed on May 26, 2011.

(51) Int. Cl. G06Q 10/08

(52) U.S. Cl. 705/7.12

(57) ABSTRACT

A method for enabling collaborative planning, learning, and service supply chain execution using collaborative distributed nodes (CDNs) to fulfill aftermarket service needs of a company in a hierarchical and dynamic environment where products are serviced in a multitude of geographies. The method allows accelerated decision and planning function in the supply chain sub chains, and post-sales services supply chain leading to dynamic, efficient and optimized planning and collaborative execution.

### CROSS-REFERENCE TO RELATED APPLICATIONS

This application claims the benefit of U.S. Provisional Application No. 61/490,137 filed on May 26, 2011, of which the entirety is incorporated herein by reference.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

1. Field of the Invention.

The present invention is in the field of Service Supply Chain Management. More particularly, the present invention is in the field of business process and service operation of a Service Supply chain.

2. Description of Related Art.

Service Chain Management conventionally has been a process run by multiple regionally distributed teams in a company, and business processes and methods have not evolved to address the complexities introduced due to global aftermarket service needs. As product life cycles become shorter and as products need to be sold and serviced globally, there is a need for a multitude of processes to enable the service supply chain to react to these needs, and meet the goals of improving customer satisfaction while executing the service supply chain functions efficiently.

### SUMMARY OF THE INVENTION

The present invention is a business process and method that enables collaborative planning, learning, and service supply chain execution using collaborative distributed nodes (CDNs) to fulfill aftermarket service needs of a company in a hierarchical and dynamic environment where products are serviced in a multitude of geographies.

### BRIEF DESCRIPTION OF THE SEVERAL VIEWS OF THE DRAWINGS

FIG. 1. Business Process and System Model—collaboration between Hubs (Central/Regional) and Collaborative Distributed Node Satellites (Inter and Intra)

FIG. 2. Business Process and System Model—Hub

FIG. 3. Business Process and System Model Collaborative Distributed Node—Satellite.

### DETAILED DESCRIPTION OF THE INVENTION

The business process, system and method being proposed introduces a system of collaborative distributed nodes (CDNs) for aftermarket service chain management, with a central “Hub” or multiple “Hubs” and a “Satellite” or multiple “Satellites”. This system and method supports the new age requirements of higher velocity in decision support and provides end to end views across multiple supply chains, service chains and sub chains. It facilitates monitoring and visibility across the supply chains and service chains with demand, inventory, supply and financials that are collaboratively shared for decision making with the head office and/or regional offices.

The framework consists of nodes called “Hubs” that individually or collectively sharing in a continuous transmitting/broadcasting mode over a link (virtual or otherwise) that transmits data and scenarios for decision making/support based on multiplicity of information inputs and business rules for CDN satellite nodes. The key difference from centralized material management systems is that the information packets may be derived from multiple source inputs. The satellite nodes are workstations at different locations communicating via electronic and mechanical means. The content transmitted consists of information packets that contain (a) data, (b) context, and (c) time-sensitive information related to a multitude of parameters such as service part fulfillment status, life-cycle data, and dynamic variables for customer part requests. Collaborative sharing is broader than just the customer, financial, operational, demand, supply, and inventory metrics and also applies across supply chains and sub chains.

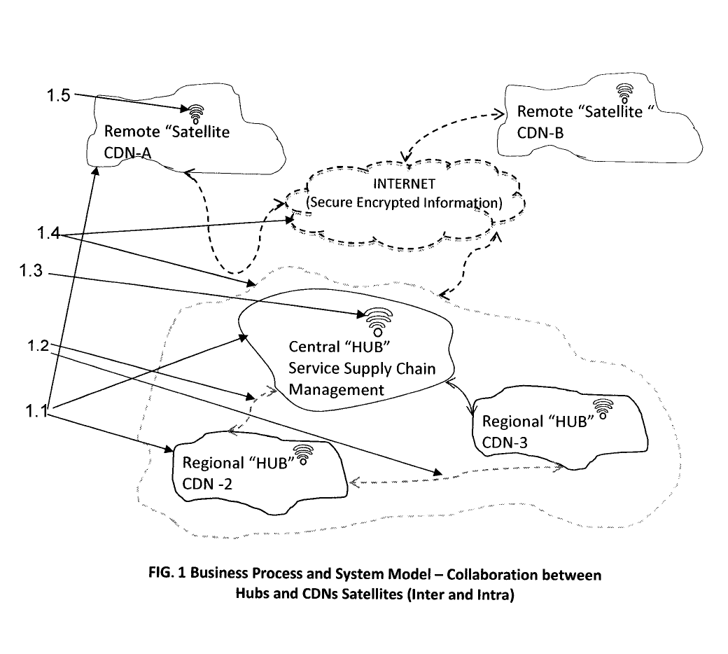

Referring now to the invention in more detail, in FIG. 1 a business process and system model is shown. 1.1 refers to the Central “HUB”, and Remote “Satellite(s)” and Regional “HUB”(s). 1.2 refers to the secure encrypted flow of information and interconnection through multiple methods, not limited to Virtual Private Networks (VPN), Secure Shell (SSH) and Secure Socket Layer (SSL) over the Internet and/or intranet, between the Remote “Satellite(s)”, the Central/Regional “HUB(s)” and between themselves respectively (inter and intra). The flow of information enables the catalytic learning capability of the system allowing for context sensitive collaborative reporting, decision making and recommendations. The mechanism allows for the comparison of multiple scenarios with visualization of outcomes and is available for sharing and comparing with scalar and vector methods.

The Systems—CDNs—Hubs and Satellites have secure sharing, synchronizing and authentication mechanisms with high availability, self-healing and reporting mechanisms. 1.3 and 1.5 refers to the broadcasting and receiving capability with special user interface mechanism that allows context sensitive collaboration between Hubs and Satellites [Inter and Intra]. The Satellites can subscribe to certain information channels from the Hubs and fellow Satellites. 1.4 refers to the Cloud as a secure and reliable storage and transport vehicle either in a private intranet and/or the Internet or any other means electronic or mechanical.

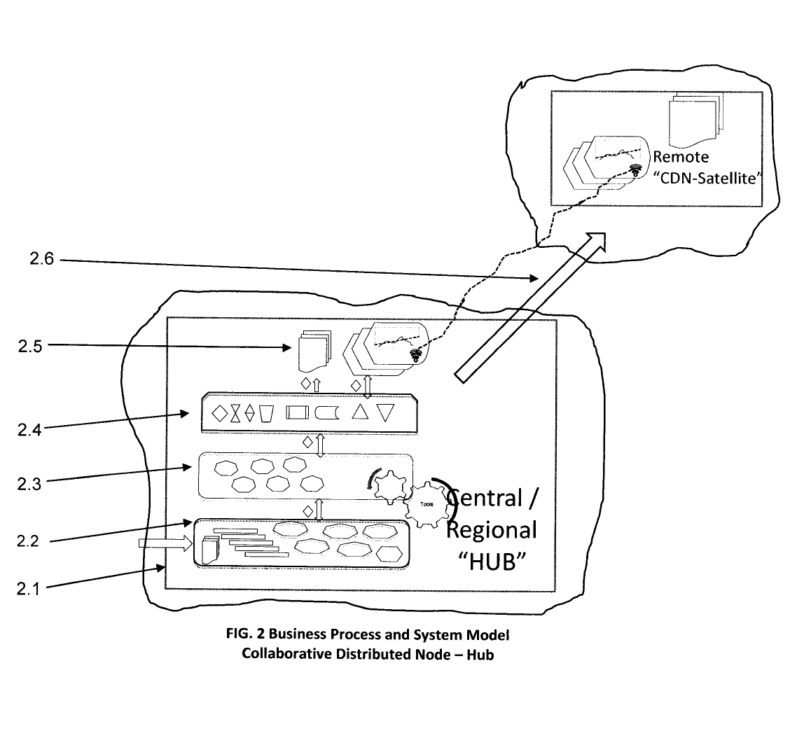

Referring now to FIG. 2, the business process and system model of CDN—Hub is detailed. 2.1 refers to the HUB comprising of input methods and output methods for receiving one or more information data packets and for transmitting one or more status to a content source, for receiving one or more status from an end user, at least one processing unit coupled to the Hub and/ or Satellite, and memory for storing them locally or remotely with one or more data packet streams responsive to receiving the data packet(s). This could be extended into linking and the demand movement of a sub part chain to all collaborating entities based on pre-defined and or tunable broadcast request. The content source could be from different systems/methods (disparate/heterogeneous data sets) that are processed or preprocessed and sent to an end user over a link or on a virtual communication channel. 2.2 refers to the collection and connection system not limited to disparate data, multiple systems, mapping of parts, multiple vendors, and business rules. 2.3 refers to the system and process of data manipulation and application of different types of tools, algorithms, analytics, expert systems and not limited to computer software. 2.4 refers to the collation, sorting, hashing, storing, and other methods of processing information and 2.5 refers to the display and reporting of information not limited to financial metrics, what—if scenarios, operational metrics, supplier metrics, demand, inventory, services, solutions, dash boards, heat-maps and ad hoc special reports also mechanism for monitoring metrics, visualization and broadcasting on multiple channels with authentication, encryption and collaborative learning. The number 2.6 refers to a secure encrypted information flow between the “CDN-Satellite” and “Hub”.

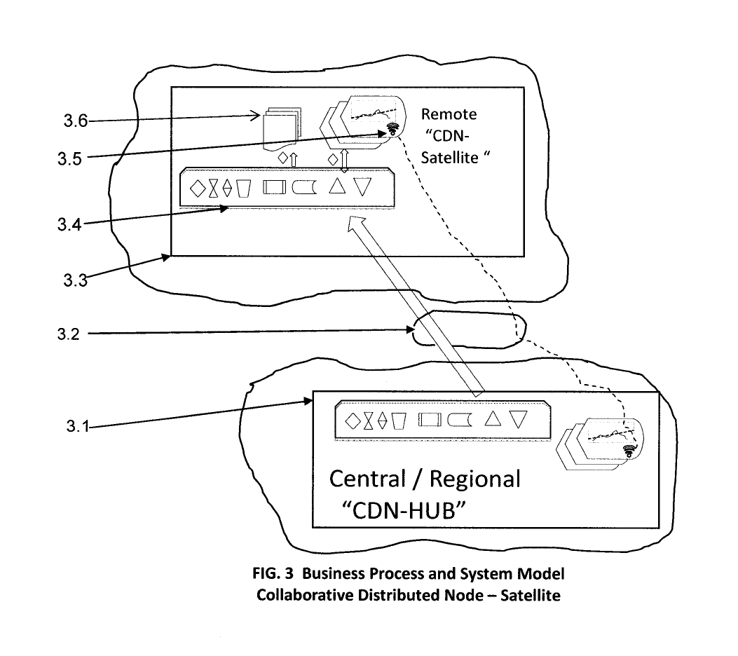

Referring now to FIG. 3, the business process and system model of CDN—Satellite is detailed. 3.1 refers to a central and or regional hub as detailed in FIG. 2.0. 3.2 refers to the secure encrypted information flow between the “Hub” and the CDN “Satellite” entities. Further 3.3 indicates the CDN-Satellite in its entirety with 3.4 representing the refers to the collation, sorting, hashing, storing, and other methods of processing information and 3.5 refers to the receiving/broadcasting entity, 3.6 refers to the display and reporting of information not limited to financial metrics, what—if scenarios, operational metrics, supplier metrics, demand, inventory, services, solutions, dash boards, heat-maps and ad hoc special reports also mechanism for monitoring metrics, visualization and broadcasting on multiple channels with authentication, encryption and collaborative learning.

The associated methods and optimization models, algorithms are stored in the memory—physical and or electronically. The optimization codes and methods, when executed, provides the end user with various scenario planning decision variables, which provide status information, semaphores, context and also transmit status information, the quality of service assigned by and to the end user is also determined. The session specific status and scenarios based on context sensitive collaborative efforts with catalytic learning capability built upon by dynamic sensors (pre assigned or tunable) are shared by one or CDNs. The CDNs also have on demand and/or tunable broadcast ready outputs that allows sharing and/production of multiplicity of reports for decision making and recommendations for risk assessment and management of the supply chains in an optimal fashion. The broadcasting/receiving between the CDNs (Hubs and Satellites) could be controlled by the originator of the broadcast, the end user can also tune into the info channel based on business priority or point of interest and can collaborate. The CDN—Satellites can also tune into session specific status via multiple formats to the user at the CDN-Satellite as well as the Hub.

The advantages of the present invention include, without limitation, an agile and flexible model that can apply to a global, regional or a local infrastructure that scales easily for operation. It is a business method and process for post-sales services supply chain that can be setup very quickly and started easily due to the size and plug and play nature of the setup. It facilitates decisions with higher accuracy and gives visibility across supply chains and sub chains, with reporting and with action to change future events that results in savings, reduced wastage and increase in execution velocity.

What is claimed is:

1. A method of system that utilizes collaborative distributed nodes for aftermarket service chain management :
Providing a CDN in communication with another CDN or with itself via a network and uses multiple information objects;
Providing and monitoring of a variable or set of variables comprising of information object associated with one or more activities performed on a part or parts in supply chain sub chains, and post-sales services supply chain;
Determining availability of said one or more information objects for said part or in said CDN or CDN's;
Generating a visual representation of said one or more information objects or said part or parts by said CDN based on availability—past, present and future, wherein, said user or users accesses the visual partly or wholly on different devices;
Collaborating and broadcasting between different CDN's and initiating transactions between CDN's for actions with a time shift or in real time based on user inputs and utilizing flags and or reference pointers; and
Initiating one or more actions associated with said part or parts and delivering it using visuals with flags and or reference pointers.
